(19) United States
(12) Patent Application Publication
(10) Pub. No.: US 2017/0310406 A1
(43) Pub. Date: Oct. 26, 2017

(54) PARAMETER DETERMINATION METHOD, INTERFERENCE CLASSIFICATION AND IDENTIFICATION METHOD AND APPARATUSES THEREOF

(71) Applicant: FUJITSU LIMITED, Kawasaki-shi (JP)

(72) Inventors: Lefei WANG, Beijing (CN); Hao Wang, Beijing (CN); Su YI, Beijing (CN); Xiaojing FAN, Beijing (CN); Wenqian XUE, Beijing (CN)

(21) Appl. No.: 15/486,768

(22) Filed: Apr. 13, 2017

(30) Foreign Application Priority Data
Apr. 21, 2016 (CN) 201610251887.0

(51) Int. Cl. H04B 17/345; H04W 84/18

(52) U.S. Cl. CPC H04B 17/345; H04W 84/18

(57) ABSTRACT

Embodiments of this disclosure provide a parameter determination method, an interference classification and identification method and apparatuses thereof. Wherein, the interference classification and identification method includes: for Q moments, detecting K first network parameters at each moment, so as to obtain a third parameter sequence constituted by the K first network parameters at the Q moments; and respectively determining classes of interference states existing at the Q moments according to the third parameter sequence and a hidden Markov model. Furthermore, the embodiments provide a method for determining parameters in the above hidden Markov model. With the method of the embodiments, the parameters in the above hidden Markov model may be easily determined. Wherein, by simplifying a parameter sequence based on a threshold value, the parameter sequence is made to be a limited set, which may lower the complexity of determining the parameters in the hidden Markov model. Furthermore, the problem of interference classification and identification may be converted into a problem of decoding, which lowers the complexity in achievement.

### TECHNICAL FIELD

This disclosure relates to the field of communication technologies, and in particular to a parameter determination method, an interference classification and identification method and apparatuses thereof.

### BACKGROUND

In the existing wireless communication technologies, many of them use the same band. For example, in the 2.4 GHz band, wireless local networks based on the IEEE 802.11b Standard, such as the wireless Fidelity (WiFi), Bluetooth, and a microwave oven (MWO), and wireless local networks based on the IEEE 802.15.4 Standard, such as the Zigbee network, use this band in operation.

FIGS. 1A-1D are schematic diagrams of the WiFi, Bluetooth, MWO and Zigbee operating at the 2.4 GHz band, respectively. As shown in FIG. 1A, the WiFi network is a wideband system having 14 channels, with a channel bandwidth of 22 MHz and maximum transmission power of 20 dBm. As shown in FIG. 1B, the Bluetooth network is a hop narrowband system having 79 channels, with a channel bandwidth of 1 MHz and transmission power of 0 dBm, 4 dBm or 20 dBm. The MWO network has different models, the different models having a period of 60 Hz and having a narrowband characteristic, such as the model shown in FIG. 1C. As shown in FIG. 1D, the Zigbee network has 16 channels, a bandwidth of each channel being 2 MHz, and its typical transmission power being 20 dBm. Hence, the WiFi, Bluetooth, MWO and Zigbee networks interfere with each other. For example, when the Zigbee network operates at a channel 20, the WiFi network operating by using channels 7-10 will interfere with the Zigbee network. Likewise, the MWO network and the Bluetooth network operating by using channels 47-49 will also interfere with the Zigbee network.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

In the prior art, a method for classifying and identifying interference based on a hidden Markov model (HMM) has been proposed (Document 1), in which an expectation maximization (EM) algorithm is used to train parameters in the hidden Markov model. However, it was found in studies that the above method for constructing an HMM is high in complexity, and is relatively hard to carry out.
Document 1: Zhiyuan Weng, Phillip Orlik, and Kyeong Jin Kim, Classification of Wireless Interference on 2.4 GHz Spectrum, WCNC IEEE, pp. 786-791, 6-9 Apr. 2014.

Embodiments of this disclosure provide a parameter determination method, an interference classification and identification method and apparatuses thereof, in which the parameters in the hidden Markov model may be easily determined; wherein, by simplifying a parameter sequence based on a threshold value, the parameter sequence is made to be a limited set, which may lower the complexity of determining the parameters in the hidden Markov model. Furthermore, the problem of interference classification and identification may be converted into a problem of decoding, which lowers the complexity in achievement.

The above object of the embodiments of this disclosure is achieved by the following technical solutions.

According to a first aspect of the embodiments of this disclosure, there is provided a parameter determination apparatus for interference classification and identification, wherein the number of interference sources interfering with a current network is M, the apparatus including:

a first determining unit configured to determine M groups of parameters for M interference states of each of the M interference sources which is a primary interference source interfering with the current network, each group of parameters including a second number N1 of parameter values, a sum of the N1 parameter values being equal to 1;

wherein, the first determining unit includes: a first detecting unit, a first processing unit and a second determining unit, in determining a group of parameters in an interference state, the first detecting unit being configured to, for a third number T of moments, detect a predetermined fourth number K of first network parameters at each moment, so as to obtain a first parameter sequence constituted by the K first network parameters at the T moments;

the first processing unit being configured to optimize the K first network parameters at each moment, so as to obtain a second parameter sequence constituted by K second parameters at the T moments obtained by optimizing the first network parameters;

and the second determining unit being configured to determine probabilities of occurrence of N1 parameter states at the interference state according to the second parameter sequence, and take the probabilities as the N1 parameter values; wherein, the parameter states are determined by L second parameters to which a fifth number L of predetermined conditions correspond, N1=L^{K};

and wherein, in optimizing the K first network parameters at each moment, the first processing unit is further configured to respectively determine one of L predetermined conditions satisfied by each of the K first network parameters, and convert each of the first network parameters into a second parameter to which a predetermined condition satisfied by the first network parameter correspond, so as to obtain K second parameters at the moment; wherein, each of the predetermined conditions respectively corresponds to a second parameter, and different predetermined conditions correspond to different second parameters.

According to a second aspect of the embodiments of this disclosure, there is provided a parameter determination apparatus for interference classification and identification, wherein the number of interference sources interfering with a current network is M, the apparatus including:

a third determining unit configured to determine a first number of groups of parameters for a first number of interference states of each of the first number of interference sources which is a primary interference source interfering with the current network, each group of parameters including the first number of parameter values, a sum of the first number of parameter values being equal to 1;

wherein, the third determining unit includes a fourth determining unit configured to, in determining a group of parameters in an interference state, determine at the interference state, the first number of conversion probabilities of a first interference source at a first moment in being respectively converted into different second interference sources at a second moment, by using channels occupied by the interference source and signal strength of the interference source, so as to obtain the first number of parameter values; wherein, the first interference source at the first moment is a primary interference source at the interference state, and the second interference sources at the second moment are the primary interference source and other interference sources than the primary interference source of a number of the first number minus 1, respectively.

According to a third aspect of the embodiments of this disclosure, there is provided an interference classification and identification apparatus, wherein the number of interference sources interfering with a current network is M, the apparatus including:

a second detecting unit configured to, for a sixth number Q of moments, detect K first network parameters at each moment, so as to obtain a third parameter sequence constituted by the K first network parameters at the Q moments;

a fifth determining unit configured to respectively determine classes of interference states existing at the Q moments according to the third parameter sequence and a hidden Markov model;

wherein, the apparatus further includes:

the apparatus as described in the first aspect and configured to determine a first parameter for interference classification and identification, the first parameter being an observation state transition probability matrix in the hidden Markov model; and/or

the apparatus as described in the second aspect and configured to determine a second parameter for interference classification and identification, the second parameter being a hidden state transition probability matrix in the hidden Markov model.

According to a fourth aspect of the embodiments of this disclosure, there is provided a parameter determination method for interference classification and identification, wherein the number of interference sources interfering with a current network is M, the method including:

determining M groups of parameters for M interference states of each of the M interference sources which is a primary interference source interfering with the current network, each group of parameters including a second number N1 of parameter values, a sum of the N1 parameter values being equal to 1;

in determining a group of parameters in an interference state, for a third number T of moments, detecting a predetermined fourth number K of first network parameters at each moment, so as to obtain a first parameter sequence constituted by the K first network parameters at the T moments;

optimizing the K first network parameters at each moment, so as to obtain a second parameter sequence constituted by K second parameters at the T moments obtained by optimizing the first network parameters;

determining probabilities of occurrence of N1 parameter states at the interference state according to the second parameter sequence, and taking the probabilities as the N1 parameter values; wherein, the parameter states are determined by L second parameters to which a fifth number L of predetermined conditions correspond, N1=L^{K};

wherein, in optimizing the K first network parameters at each moment, the method includes:

respectively determining one of L predetermined conditions satisfied by each of the K first network parameters, and converting each of the first network parameters into a second parameter to which a predetermined condition satisfied by the first network parameter correspond, so as to obtain K second parameters at the moment; wherein, each of the predetermined conditions respectively corresponds to a second parameter, and different predetermined conditions correspond to different second parameters.

According to a fifth aspect of the embodiments of this disclosure, there is provided a parameter determination method for interference classification and identification, wherein the number of interference sources interfering with a current network is M, the method including:

determining a first number of groups of parameters for a first number of interference states of each of the first number of interference sources which is a primary interference source interfering with the current network, each group of parameters including the first number of parameter values, a sum of the first number of parameter values being equal to 1;

wherein, in determining a group of parameters in an interference state, the method includes:

determining at the interference state, the first number of conversion probabilities of a first interference source at a first moment in being respectively converted into different second interference sources at a second moment, by using channels occupied by the interference source and signal strength of the interference source, so as to obtain the first number of parameter values; wherein, the first interference source at the first moment is a primary interference source at the interference state, and the second interference sources at the second moment are the primary interference source and other interference sources than the primary interference source of a number of the first number minus 1, respectively.

According to a sixth aspect of the embodiments of this disclosure, there is provided an interference classification and identification method, wherein the number of interference sources interfering with a current network is M, the method including:

for a sixth number Q of moments, detecting K first network parameters at each moment, so as to obtain a third parameter sequence constituted by the K first network parameters at the Q moments; and

respectively determining classes of interference states existing at the Q moments according to the third parameter sequence and a hidden Markov model;

wherein, the method further includes:

determining a first parameter for interference classification and identification by using the method described in the fourth aspect, the first parameter being an observation state transition probability matrix in the hidden Markov model; and/or determining a second parameter for interference classification and identification by using the method described in the fifth aspect, the second parameter being a hidden state transition probability matrix in the hidden Markov model.

An advantage of the embodiments of this disclosure exists in that with the method and apparatus of the embodiments, the problem of interference classification and identification may be converted into a problem of decoding, which lowers the complexity in achievement. And by simplifying a parameter sequence based on a threshold value, the parameter sequence is made to be a limited set, which may lower the complexity of determining the parameters in the hidden Markov model.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including/comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be exaggerated or reduced.

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

In the drawings:

FIGS. 1A-1D are schematic diagrams of the WiFi, Bluetooth, MWO and Zigbee operating at the 2.4 GHz band, respectively;

FIG. 2 is a flowchart of the parameter determination method of Embodiment 1;

FIG. 3 is a flowchart of step 202 of the method of Embodiment 1;

FIG. 4 is a flowchart of step 203 of the method of Embodiment 1;

FIG. 5 is a flowchart of the parameter determination method of Embodiment 2;

FIG. 6 is a flowchart of calculating a conversion probability in step 501 of Embodiment 2;

FIG. 7 is a flowchart of a method for determining M×N1 parameters of this embodiment;

FIG. 8 is a flowchart of a method for determining M×M parameters of this embodiment;

FIG. 9 is a flowchart of the interference classification and identification of Embodiment 4;

FIG. 10 is a schematic diagram of the parameter determination apparatus of Embodiment 5;

FIG. 11 is a schematic diagram of a second determining unit 10013 of Embodiment 5;

FIG. 12 is a schematic diagram of a hardware structure of the parameter determination apparatus of Embodiment 5;

FIG. 13 is a schematic diagram of the parameter determination apparatus of Embodiment 6;

FIG. 14 is a schematic diagram of a fourth determining unit 13011 of Embodiment 6;

FIG. 15 is a schematic diagram of a hardware structure of the parameter determination apparatus of Embodiment 6;

FIG. 16 is a schematic diagram of a hardware structure of a modeling apparatus of Embodiment 7;

FIG. 17 is a schematic diagram of the interference classification and identification apparatus of Embodiment 7; and

FIG. 18 is a schematic diagram of a hardware structure of the interference classification and identification apparatus of Embodiment 7.

### DETAILED DESCRIPTION

These and further aspects and features of the present invention will be apparent with reference to the following description and attached drawings. The implementations are illustrative only, and are intended to limit this disclosure. For the principle and implementations of this disclosure to be easily understood by those skilled in the art, the embodiments of this disclosure shall be described taking the 2.4 GHz band network at an example. However, it should be understood that the embodiments of this disclosure are not limited to the 2.4 GHz band network. For example, the methods and apparatuses provided by the embodiments of this disclosure are also applicable to other networks needing to perform interference classification and identification.

The HMM is a kind of statistical analysis model, which may be expressed by λ=(A, B, π); where, A is a hidden state transition probability matrix, B is an observation state transition probability matrix, and π is an initial probability matrix. In this embodiment, each element in matrix A refers to a conversion probability between interference states at a neighboring moment, each element in matrix B refers to a probability of occurrence of a network parameter in an interference state which represents a network state. With the method and apparatus of this embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

The implementations of this disclosure shall be described below in detail with reference to the accompanying drawings.

### Embodiment 1

Embodiment 1 provides a parameter determination method, which is used for determining elements used for constructing matrix B in the HMM.

In this embodiment, M groups of parameters are determined for a scenario where each of a first to an M-th interference sources is a primary interference source interfering with the current network, so that matrix B in the HMM is constructed by the M groups of parameters. Wherein, a scenario where an interference source is a primary interference source is taken as an interference state. Hence, there exist total M interference states.

In this embodiment, when the number of the interference sources interfering with the current network is a first number (M), the method includes: determining M groups of parameters for M interference states of each of the M interference sources which is a primary interference source interfering with the current network; wherein, each group of parameters includes a second number (N1) of parameter values, a sum of the N1 parameter values being equal to 1. Hence, the M×N1 parameters correspond to M×N1 constitutional elements in matrix B in the HMM.

In this embodiment, in determining a group of parameters in an interference state, the method shown in FIG. 2 may be adopted.

FIG. 2 is a flowchart of the method for determining a group of parameters in an interference state. As shown in FIG. 2, the method includes:

step 201: for T moments, a predetermined fourth number K of first network parameters are detected at each moment, so as to obtain a first parameter sequence constituted by the K first network parameters at the T moments;

step 201: the K first network parameters at each moment are optimized, so as to obtain a second parameter sequence constituted by K second parameters at the T moments obtained by optimizing the first network parameters;

step 203: probabilities of occurrence of N1 parameter states at the interference state are determined according to the second parameter sequence, and taking the probabilities as the N1 parameter values;

wherein, the parameter states are determined by L second parameters to which a fifth number L of predetermined conditions correspond, N1=L^{K}.

In this embodiment, M, K, N1, L and T are positive integers.

In step 201, the first network parameters are taken as observation parameters of the HMM and the number of the first network parameters may be one or more. For example, the first network parameters may be one or more of RSSI, LQI and CCA; however, this embodiment is not limited thereto. When the first network parameters are RSSI, LQI and CCA, the first parameter sequence constituted at the T moments is {(RSSI₀, LQI₀, CAA₀), (RSSI₁, LQI₁, CAA₁) . . . (RSSI_{T-1}, LQI_{T-1}, CAA_{T-1})}. In step 202, as values of the first network parameters are different, the first parameter sequence is not a limited set, and complexity of determining parameters is relatively high. Hence, the K first network parameters at each moment may be optimized, so as to lower the complexity of determination.

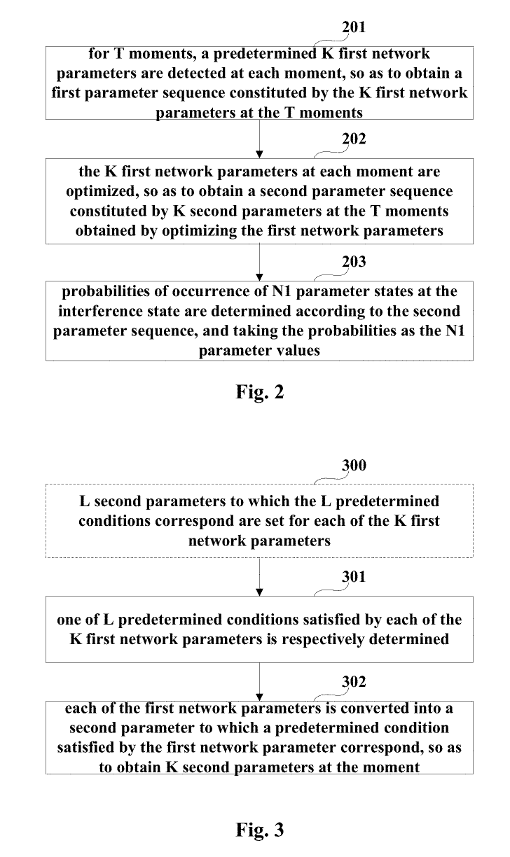

FIG. 3 is a flowchart of the method for optimizing the K first network parameters at a moment in step 202. As shown in FIG. 3, the method includes:

step 301: one of L predetermined conditions satisfied by each of the K first network parameters is respectively determined; and

step 302: each of the first network parameters is converted into a second parameter to which a predetermined condition satisfied by the first network parameter correspond, so as to obtain K second parameters at the moment;

In this embodiment, each of the predetermined conditions respectively corresponds to a second parameter, and different predetermined conditions correspond to different second parameters.

In this embodiment, alternatively, the method may further include:

step 300: L second parameters to which the L predetermined conditions correspond are set for each of the K first network parameters.

In step 300, for each of the K first network parameters, the L second parameters to which the L predetermined conditions correspond may be set based on threshold values, that is, the L second parameters to which the L predetermined conditions correspond are set by using L−1 threshold values. In particular, the L−1 threshold values (such as TH₀, TH₁, . . . , TH_{L-2}) may divide values of the first network parameters into L intervals (−∞, TH₀], (TH₀, TH₁], ( . . . ], (TH_{L-2}, +∞], which respectively correspond to the above L predetermined conditions. And one second parameter is set for each interval, and L second parameters are set totally. Wherein, the L second parameters to which the L predetermined conditions correspond are different. Furthermore, for the K first network parameters, K×(L−1) threshold values are set; and for different K first network parameters, the set L−1 threshold values are different, but the second parameters are identical.

For example, for the first network parameters i, L second parameters P₀, P₁, . . . , P_{L-1} to which the L predetermined conditions correspond are set based on the threshold values, the threshold values TH₀, TH₁, . . . , TH_{L-2} divide the values of the first network parameters i into L intervals, and after being optimized, the first network parameters i is equal to:

$$i = \{ \begin{matrix}{P}_{0} & i \leq {TH}_{0} \\ {P}_{1} & {TH}_{0} < i \leq {TH}_{1} \\ & … \\ {P}_{i} & {TH}_{i - 1} < i \leq {TH}_{i} \\ & … \\ {P}_{L - 1} & i > {TH}_{L - 2}\end{matrix} ;$$

where, values of i are from 1 to K.

in steps 301 and 302, for the K first network parameters at a moment, one of the L predetermined conditions satisfied by each of the first network parameters is respectively determined. For example, an interval in step 300 to which values of the first network parameters belong is determined first, then the first network parameters are converted into second parameters to which the interval corresponds, so as to obtain K second parameters at this moment. By optimizing the K first network parameters at T moments by using the above method, the second parameter sequence constituted by K second parameters obtained by optimizing the first network parameters at the T moments may finally be obtained.

For example, for each of the first network parameters, when L is 2, the number of the threshold values is 1, such as TH. The threshold value divides the first network parameters into two intervals, a first interval less than or equal to the threshold value, i.e. (−∞, TH], and a second interval greater than the threshold value, i.e. (THi, +∞]. And a second parameter is set respectively for each interval; for example, a first numeral value is set for the first interval, and a second numeral value is set for the second interval. In this way, when it is determined that the first network parameters are greater than the threshold value, that is, when it is determined that the first network parameters satisfy the second interval, the first network parameters are converted into the second numeral value; and when it is determined that the first network parameters are less than or equal to the threshold value, that is, when it is determined that the first network parameters satisfy the first interval, the first network parameters are converted into the first numeral value; for example, the first numeral value is 0, and the second numeral value is 1, and vice versa. However, this embodiment is not limited thereto.

FIG. 4 is a flowchart of step 203. As shown in FIG. 4, the method includes:

step 401: the number of times of occurrence of each of the N1 parameter states at the T moments are counted in the second parameter sequence; and

step 402: the number of times of occurrence of each parameter state is divided by T, so as to obtain the probabilities of occurrence of the N1 parameter states, and the probabilities are taken as the N1 parameter values.

In this embodiment, accuracy of the probabilities are related to T, and the larger the T, the more accurate the calculated probabilities.

The above parameter determination method shall be described below by way of an example. For example, the current network is a Zigbee network, and the interference resources interfering with the Zigbee network includes M=3 interference resources which are Bluetooth, WiFi, and MWO, respectively; there exist M=3 interference states, which are that WiFi is the primary interference resource interfering with the current network (the first interference state), that MWO is the primary interference resource interfering with the current network (the second interference state), that Bluetooth is the primary interference resource interfering with the current network (the third interference state), respectively. Hence, a group of parameters in each interference state need to be determined, that is, there are totally three groups of parameters, each group of parameters including N1 parameter values. Thus, in this example, M=3, and there are three predetermined first network parameters, that is, K=3; and there are two predetermined conditions, that is, L=2, each group of parameters including 8 parameter values, that is, N1=2³=8.

In step 201, the first parameter sequence at the T moments is obtained; for example, the first parameter sequence may be:

{(RSSI₀, LQI₀, CAA₀), (RSSI₁, LQI₁, CAA₁) . . . (RSSI_{T-1}, LQI_{T-1}, CAA_{T-1})};

where, T may be any value, for example, T=100. Hence, when it is determined that the first network parameters are greater than the threshold value, that is, when it is determined that the first network parameters satisfy the second interval, the first network parameters are converted into the second numeral value; and when it is determined that the first network parameters are less than or equal to the threshold value, that is, when it is determined that the first network parameters satisfy the first interval, the first network parameters are converted into the first numeral value; for example, the first numeral value is 0, and the second numeral value is 1.

In step 202, thresholds TH_{R}, TH_{L} and TH_{C} are respectively set for RSSI, LQI and CAA. Values of RSSI may be divided into two intervals, i.e. a first interval (−∞, TH_{R}] and a second interval (TH_{R},+∞], and second parameters are respectively set for each interval, for example, the first numeral value 0 is set for the first interval, and the second numeral value 1 is set for the second interval. Likewise, values of LQI may be divided into two intervals, i.e. a first interval (−∞, TH_{L}] and a second interval (TH_{L}, +∞], and second parameters are respectively set for each interval, for example, the first numeral value 0 is set for the first interval, and the second numeral value 1 is set for the second interval; and values of CAA may be divided into two intervals, i.e. a first interval (−∞, TH_{C}] and a second interval (TH_{C}, +∞], and second parameters are respectively set for each interval, for example, the first numeral value 0 is set for the first interval, and the second numeral value 1 is set for the second interval; that is,

$$RSSI = \{ \begin{matrix}1 & RSSI > {TH}_{R} \\ 0 & RSSI \leq {TH}_{R}\end{matrix} , \\ LQI = \{ \begin{matrix}1 & LQI > {TH}_{L} \\ 0 & LQI \leq {TH}_{L}\end{matrix} , \\ CCA = \{ \begin{matrix}1 & CCA > {TH}_{C} \\ 0 & CCA \leq {TH}_{C}\end{matrix} .$$

Thus, when RSSI₀ satisfies the first interval, it is converted into 0, and when RSSI₀ satisfies the second interval, it is converted into 1. Processing of LQI₀, CAA₀, RSSI₁, LQI₁, CAA₁ . . . RSSI_{T-1}, CAA_{T-1} is similar to that of, which shall not be described herein any further. With the above simplification, the second parameter sequence obtained by converting the first parameter sequence is a limited set, in which only N1 possible parameter states exist, N1=L^{K}, that is, N1=2³=8 possible parameter states, which are (0, 0, 0), (0, 0, 1), (0, 1, 0), (0, 1, 1), (1, 0, 0), (1, 0, 1), (1, 1, 0), (1, 1, 1), that is, the second parameter sequence after being simplified may be {(0, 1, 0), (1, 0, 1), . . . , (0, 0, 1)}.

In step 203, probabilities of occurrence of T=100 observation results (0, 1, 0), (1, 0, 1), . . . , (0, 0, 1) in the second parameter sequence are respectively determined, and the probabilities are taken as 8 parameter values in the current interference state.

Therefore, N1 parameter values in the interference state where WiFi is the primary interference resource interfering with the current network are and a sum of them is 1; N1 parameter values in p_{w0}, p_{w1}, p_{w2}, p_{w3}, p_{w4}, p_{w5}, p_{w6}, p_{w7}, the interference state where MWO is the primary interference resource interfering with the current network are pₘ₀, pₘ₁, pₘ₂, pₘ₃, pₘ₄, pₘ₅, pₘ₆, pₘ₇, and a sum of them is 1; N1 parameter values in the interference state where Bluetooth is the primary interference resource interfering with the current network are p_{b0}, p_{b1}, p_{b2}, p_{b3}, p_{b4}, p_{b5}, p_{b6}, p_{b7}, and a sum of them is 1; and

$${P}_{ji} = \frac{Number}{T} ,$$

j=w, m, b; i=0, 1, . . . , 7.

That is, the 3×8 parameters correspond to 3×8 constitutional elements in matrix B in the HMM, and matrix B is as shown below (wherein, the first to third rows respectively correspond to the first to third interference states, and first to eighth columns respectively correspond to N1=8 parameter states, (0, 0, 0), (0, 0, 1), (0, 1, 0), (0, 1, 1), (1, 0, 0), (1, 0, 1), (1, 1, 0), (1, 1, 1)):

$$B = [ \begin{matrix}{p}_{w 0} & {p}_{w 1} & {p}_{w 2} & {p}_{w 3} & {p}_{w 4} & {p}_{w 5} & {p}_{w 6} & {p}_{w 7} \\ {p}_{m 0} & {p}_{m 1} & {p}_{m 2} & {p}_{m 3} & {p}_{m 4} & {p}_{m 5} & {p}_{m 6} & {p}_{m 7} \\ {p}_{b 0} & {p}_{b 1} & {p}_{b 2} & {p}_{b 3} & {p}_{b 4} & {p}_{b 5} & {p}_{b 6} & {p}_{b 7}\end{matrix} ] .$$

The Zigbee network being the current network is described above. However, this embodiment is not limited thereto; for example, the current network may be WiFi, in which case an interference source posing interference may be one or more of Bluetooth, Zigbee and MWO. And a parameter determination method is similar to that described above, and shall not be described herein any further.

With the above embodiment, parameters in the HMM are relatively easy to be determined. Wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

### Embodiment 2

Embodiment 2 provides a parameter determination method, which is used for determining elements used for constructing matrix A in the HMM.

In this embodiment, M groups of parameters are determined for a scenario where each of a first to an M-th interference sources is a primary interference source interfering with the current network, so that matrix A in the HMM is constructed by the M groups of parameters. Wherein, a scenario where an interference source is a primary interference source is taken as an interference state. Hence, there exist total M interference states.

In this embodiment, when the number of the interference sources interfering with the current network is a first number (M), the method includes: determining M groups of parameters for M interference states of each of the M interference sources which is a primary interference source interfering with the current network; wherein, each group of parameters includes M parameter values, a sum of the M parameter values being equal to 1. Hence, the M×M parameters correspond to M×M constitutional elements in a hidden state transition probability matrix A in the HMM.

In this embodiment, in determining a group of parameters in an interference state, the method shown in FIG. 5 may be adopted.

FIG. 5 is a flowchart of the method for determining a group of parameters in an interference state. As shown in FIG. 5, the method includes:

step 501: M conversion probabilities of a first interference source at a first moment in being respectively converted into different second interference sources are determined at a second moment, by using channels occupied by the interference source and signal strength of the interference source, so as to obtain M parameter values;

In this embodiment, the first interference source at the first moment is a primary interference source at the interference state, and the second interference sources at the second moment are the primary interference source and other M−1 interference sources than the primary interference source, respectively.

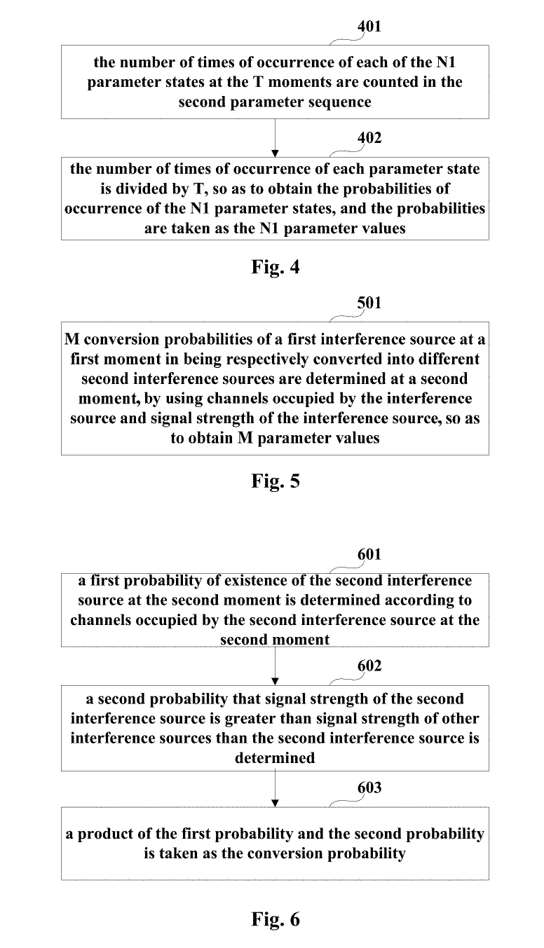

FIG. 6 is a flowchart of calculating a conversion probability in step 501. As shown in FIG. 6, the method includes:

step 601: a first probability of existence of a second interference source at the second moment is determined according to channels occupied by the second interference source at the second moment;

step 602: a second probability that signal strength of the second interference source is greater than signal strength of other interference sources than the second interference source is determined; and

step 603: a product of the first probability and the second probability is taken as the conversion probability.

In this embodiment, the signal strength may be expressed by transmission power, and may also be expressed by other parameters not changing along with the time, such as receiving power, etc., and this embodiment is not limited thereto.

How to determine the above parameters shall be described below taking that the current network is a Zigbee network and the number of interference sources posing interference is 3, which are WiFi, MWO and Bluetooth, as an example. Wherein, there exist three interference states, i.e. a state that WiFi is the primary interference resource interfering with the current network (the first interference state), a state that MWO is the primary interference resource interfering with the current network (the second interference state), and a state that Bluetooth is the primary interference resource interfering with the current network (the third interference state), respectively.

In this embodiment, when the first interference source at the first moment is WiFi, the second interference source at the second moment may be one of WiFi, MWO and Bluetooth; when the first interference source at the first moment is MWO, the second interference source at the second moment may be one of WiFi, MWO and Bluetooth; and when the first interference source at the first moment is Bluetooth, the second interference source at the second moment may be one of WiFi, MWO and Bluetooth.

That is, the M parameters in the first interference state at the first moment are a probability p_{ww} that WiFi is the primary interference source interfering with the current network at the second moment, a probability p_{wm} that MWO is the primary interference source interfering with the current network at the second moment, and a probability p_{wb} that Bluetooth is the primary interference source interfering with the current network at the second moment, respectively.

The M parameters in the second interference state at the first moment are a probability p_{mw} that WiFi is the primary interference source interfering with the current network at the second moment, a probability pₘₘ that MWO is the primary interference source interfering with the current network at the second moment, and a probability p_{mb} that Bluetooth is the primary interference source interfering with the current network at the second moment, respectively.

The M parameters in the third interference state at the first moment are a probability p_{bw} that WiFi is the primary interference source interfering with the current network at the second moment, a probability p_{bm} that MWO is the primary interference source interfering with the current network at the second moment, and a probability p_{bb} that Bluetooth is the primary interference source interfering with the current network at the second moment, respectively.

That is, the 3×3 parameters correspond to 3×3 constitutional elements in the hidden state transition matrix A in the HMM, and matrix A is as shown below (wherein, the first to third rows respectively correspond to the three possible interference states at the first moment, i.e. the first to third interference states, and first to third columns respectively correspond to the three possible interference states at the second moment, i.e. the first to third interference states):

$$A = [ \begin{matrix}{p}_{ww} & {p}_{wm} & {p}_{wb} \\ {p}_{mw} & {p}_{mm} & {p}_{mb} \\ {p}_{bw} & {p}_{bm} & {p}_{bb}\end{matrix} ]$$

In step 601, in determining the first probability P1, when the primary interference source is Bluetooth and the current network is Zigbee, a hopping probability that a channel used by Bluetooth coincides with a channel used by Zigbee is taken as the first probability P1; when the primary interference source is Wi-Fi and the current network is Zigbee, a probability that a channel frequency used by Wi-Fi coincides with a channel used by Zigbee is taken as the first probability P1; and when the primary interference source is MWO and the current network is Zigbee, a probability that a frequency used by the MWO coincides with a channel used by Zigbee is taken as the first probability P1.

In step 602, in determining the second probability P2, when the second interference source is Bluetooth and the current network is Zigbee, a probability that transmission power of Bluetooth is greater than transmission power of WiFi and transmission power of MWO is taken as the second probability P2; when the second interference source is WiFi and the current network is Zigbee, a probability that transmission power of WiFi is greater than transmission power of Bluetooth and transmission power of MWO is taken as the second probability P2; and when the second interference source is MWO and the current network is Zigbee, a probability that transmission power of MWO is greater than transmission power of WiFi and transmission power of Bluetooth is taken as the second probability P2.

In step 603, P1×P2 is taken as the conversion probability.

How to calculate the above parameters shall be described below taking that the current network is Zigbee and channel 20 is used as an example.

In step 601, in determining the first probability P1, when the second interference source is Bluetooth, it shows that Bluetooth uses channels 47-49, that is, the hopping probability that a channel used by Bluetooth coincides with a channel used by Zigbee is 3/79; when the second interference source is WiFi, it shows that WiFi uses channels 7-10, and a probability that a channel frequencies used by WiFi coincides with a channel used by Zigbee is 4/14 and when the second interference source is MWO, a probability that frequencies used by MWO coincides with a channel used by Zigbee is 1.

In step 602, in determining the second probability P2, when the second interference source is Bluetooth, the probability that the transmission power of Bluetooth is greater than the transmission power of WiFi and the transmission power of MWO is p_{b>w}×p_{h>m}; when the second interference source is WiFi, the probability that the transmission power of WiFi is greater than the transmission power of Bluetooth and the transmission power of MWO is p_{w>b}×p_{w>m}; and when the second interference source is MWO, the probability that the transmission power of MWO is greater than the transmission power of WiFi and the transmission power of Bluetooth is p_{m>b}×p_{m>w}.

Wherein, p_{b>w}, p_{b>m}, p_{w>b}, p_{w>m}, p_{m>b} and p_{m>w} may be pre-obtained.

How to obtain a value shall be described below taking p_{b>w} as an example. p_{b>w} denotes the probability that the transmission power of Bluetooth is greater than the transmission power of WiFi, and may be calculated by setting the transmission power of Bluetooth and the transmission power of WiFi to be typical transmission power. For example, as typical transmission power of Bluetooth is 0 dBm, 4 dBm and 20 dBm, if maximum power 20 dBm is set for WiFi, the probability p_{b>w} that the transmission power of Bluetooth is greater than the transmission power of WiFi is 0; and if transmission power 0 dBm is set for WiFi, the probability that the transmission power of Bluetooth is greater than the transmission power of WiFi is 2/3. Furthermore, if p_{b>w} is calculated according to actual transmission power, that is, both the transmission power of Bluetooth and the transmission power of WiFi are known, the value of p_{b>w} is 1 or 0.

How to obtain p_{b>w}, p_{b>m}, p_{w>b}, p_{w>m}, p_{m>b} and p_{m>w} is illustrated above; however, this embodiment is not limited thereto.

In step 603, the conversion probabilities may be determined as:

$$A = \\ [ \begin{matrix}{p}_{ww} = 4 \text{/} 14 \times {p}_{w > b} \times {p}_{w > m} & {p}_{wm} = {p}_{m > b} \times {p}_{m > w} & {p}_{wb} = {p}_{b > m} \times {p}_{b > w} \\ {p}_{mw} = 4 \text{/} 14 \times {p}_{w > b} \times {p}_{w > m} & {p}_{mm} = {p}_{m > b} \times {p}_{m > w} & {p}_{mb} = {p}_{b > m} \times {p}_{b > w} \\ {p}_{bw} = 4 \text{/} 14 \times {p}_{w > b} \times {p}_{w > m} & {p}_{bm} = {p}_{m > b} \times {p}_{m > w} & {p}_{bb} = {p}_{b > m} \times {p}_{b > w}\end{matrix} ] .$$

That is, the 3×3 conversion probabilities correspond to 3×3 constitutional elements in matrix A in the HMM.

With the above embodiment, complexity of determining the parameters in the above hidden Markov model is lowered, and the problem of interference classification and identification may be converted into a problem of decoding, which lowers the complexity in achievement.

### Embodiment 3

Embodiment 3 provides a modeling method for interference classification and identification, in which an HHM λ=(A, B, π) is used to construct an interference classification and identification model; where, A is a hidden state transition probability matrix, B is an observation state transition probability matrix, and π is an initial probability matrix. In this embodiment, each element in matrix A refers to a probability of conversion between interference states at neighboring moments, and each element in matrix B refers to a probability of occurrence of a network parameter in an interference state which represents a network state.

In this embodiment, when the number of the interference sources interfering with the current network is a first number (M), the method includes:

taking M×N1 parameters determined by using the parameter determination method of Embodiment 1 as matrix B in the model, and/or taking M×M parameters determined by using the parameter determination method of Embodiment 2 as matrix A in the model.

In this embodiment, in determining matrix B according to the method of Embodiment 1, matrix A may be determined by using the method of Embodiment 2, or by using other methods, and this embodiment is not limited thereto.

In this embodiment, in determining matrix A according to the method of Embodiment 2, matrix B may be determined by using the method of Embodiment 1, or by using other methods, and this embodiment is not limited thereto.

In this embodiment, initial probabilities of occurrence of the interference states are taken as an initial probability matrix π; for example, it may be determined according to an actual situation, or by setting the initial probabilities of occurrence of the interference states to be identical

$$\frac{1}{M} ,$$

and this embodiment is not limited thereto.

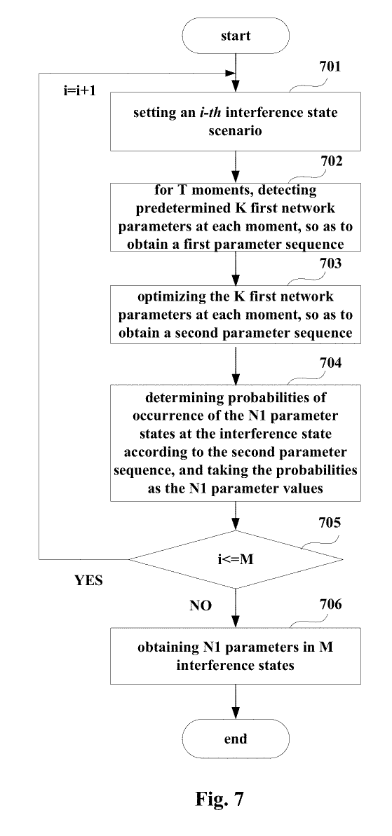

FIG. 7 is a flowchart of a method for determining M×N1 parameters of this embodiment. As shown in FIG. 7, the method includes:

step 701: setting an i-th interference state scenario;

for example, the current network may be set to be Zigbee network, and the number of interference sources posing interference is 3, which are WiFi, MWO, and Bluetooth, respectively; wherein, there exist three interference states, including that WiFi is the primary interference resource interfering with the current network (the first interference state), that MWO is the primary interference resource interfering with the current network (the second interference state), that Bluetooth is the primary interference resource interfering with the current network (the third interference state); in a first time of setting, i=1;

step 702: for T moments, detecting predetermined K first network parameters at each moment, so as to obtain a first parameter sequence constituted by the K first network parameters at the T moments;

step 703: optimizing the K first network parameters at each moment, so as to obtain a second parameter sequence constituted by K second parameters at the T moments obtained by optimizing the first network parameters;

step 704: determining probabilities of occurrence of the N1 parameter states at the interference state according to the second parameter sequence, and taking the probabilities as the N1 parameter values;

wherein, steps 201-203 may be referred to for implementations of steps 702-704, which shall not be described herein any further;

step 705: judging whether i is less than or equal to M, and letting i=i+1 and turning back to step 701 when the judging result is yes, otherwise, executing step 706; and

step 706: obtaining N1 parameters in M interference states.

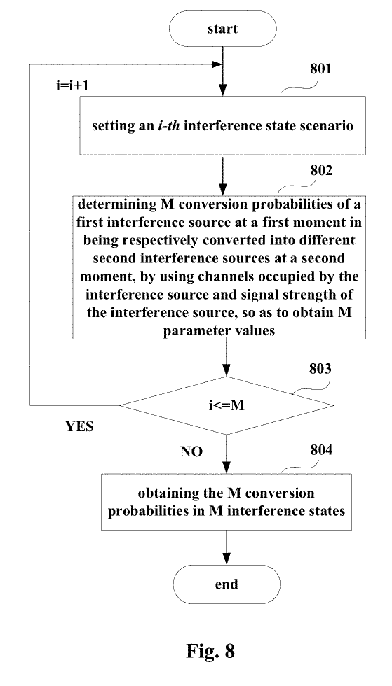

FIG. 8 is a flowchart of a method for determining M×M parameters of this embodiment. As shown in FIG. 8, the method includes:

step 801: setting an i-th interference state scenario;

for example, the current network may be set to be Zigbee network, and the number of interference sources posing interference is 3, which are WiFi, MWO, and Bluetooth, respectively; wherein, there exist three interference states, including that WiFi is the primary interference resource interfering with the current network (the first interference state), that MWO is the primary interference resource interfering with the current network (the second interference state), that Bluetooth is the primary interference resource interfering with the current network (the third interference state); in a first time of setting, i=1;

step 802: determining M conversion probabilities of a first interference source at a first moment in being respectively converted into different second interference sources at a second moment, by using channels occupied by the interference source and signal strength of the interference source, so as to obtain M parameter values;

In this embodiment, step 501 may be referred to for implementation of step 802, which shall not be described herein any further;

step 803: judging whether i is less than or equal to M, and letting i=i+1 and turning back to step 801 when the judging result is yes, otherwise, executing step 804; and

step 804: obtaining the M conversion probabilities in M interference states.

With the above embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

### Embodiment 4

Embodiment 4 provides an interference classification and identification method. In this embodiment, the number of interference sources interfering with a current network is a first number (M), and a scenario where an interference source is a primary interference source is taken as an interference state. Hence, there exist total M interference states.

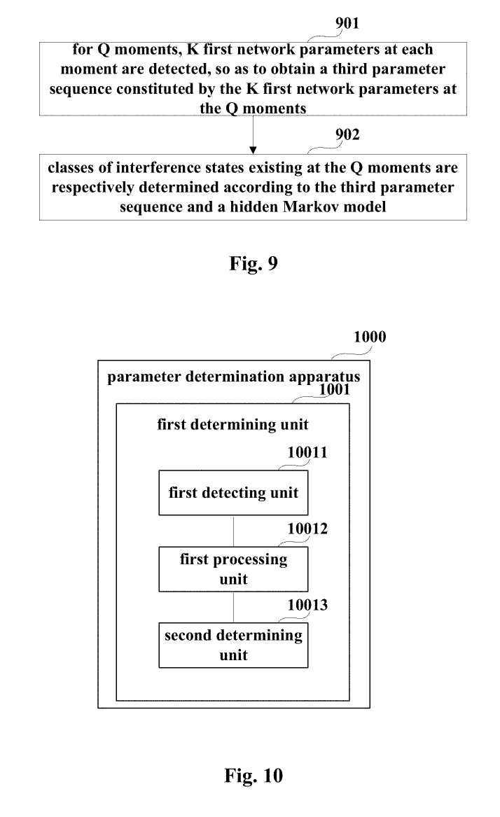

FIG. 9 is a flowchart of the interference classification and identification method. As shown in FIG. 9, the method includes:

step 901: for Q moments, K first network parameters at each moment are detected, so as to obtain a third parameter sequence constituted by the K first network parameters at the Q moments;

step 902: classes of interference states existing at the Q moments are respectively determined according to the third parameter sequence and a hidden Markov model;

in this embodiment, the hidden Markov model in step 902 may be determined by using the method in Embodiment 3, the contents of which being incorporated herein, and being not going to be described herein any further.

In this embodiment, implementation of step 901 is identical to that of step 201 in Embodiment 1, and the third parameter sequence is identical to the first parameter sequence, which shall not be described herein any further.

In step 902, the interference classification and identification method based on the HHM converts the problem of interference classification and identification into a problem of decoding. Hence, the classes of the interference states existing at the Q moments may be respectively determined by using a Viterbi algorithm according to the third parameter sequence and the hidden Markov model.

How to determine the classes of the interference states according to the Viterbi algorithm shall be described below by way of an example. In this example, for example, the number of interference sources interfering with the current Zigbee network is three (WiFi, MWO and Bluetooth).

In step 902, the third parameter sequence is converted into the second parameter sequence, such as {(0, 1, 0), (1, 0, 1), . . . , (0, 0, 1)}, a particular conversion method being similar to step 202 in Embodiment 1, and being not going to be described herein any further. For example, let Q=3, {(RSSI₀, LQI₀, CAA₀), (RSSI₁, LQI₁, CAA₁), (RSSI₂, LQI₂, CAA₂)} is converted into {(0, 1, 0), (1, 0, 0), (1, 1, 0)}.

Wherein, the HHM λ=(A, B, π) is:

matrix A pre-obtained according to the method in Embodiment 2:

$$A = [ \begin{matrix}{p}_{ww} & {p}_{wm} & {p}_{wb} \\ {p}_{mw} & {p}_{mm} & {p}_{mb} \\ {p}_{bw} & {p}_{bm} & {p}_{bb}\end{matrix} ] = [ \begin{matrix}0.5 & 0.2 & 0.3 \\ 0.3 & 0.5 & 0.2 \\ 0.2 & 0.3 & 0.5\end{matrix} ] ,$$

and matrix B pre-obtained according to the method in Embodiment 1:

$$B = [ \begin{matrix}{p}_{w 0} & {p}_{w 1} & {p}_{w 2} & {p}_{w 3} & {p}_{w 4} & {p}_{w 5} & {p}_{w 6} & {p}_{w 7} \\ {p}_{m 0} & {p}_{m 1} & {p}_{m 2} & {p}_{m 3} & {p}_{m 4} & {p}_{m 5} & {p}_{m 6} & {p}_{m 7} \\ {p}_{b 0} & {p}_{b 1} & {p}_{b 2} & {p}_{b 3} & {p}_{b 4} & {p}_{b 5} & {p}_{b 6} & {p}_{b 7}\end{matrix} ] = [ \begin{matrix}0.2 & 0.1 & 0.05 & 0.12 & 0.06 & 0.25 & 0.14 & 0.08 \\ 0.17 & 0.15 & 0.07 & 0.23 & 0.1 & 0.14 & 0.03 & 0.11 \\ 0.31 & 0.18 & 0.03 & 0.15 & 0.08 & 0.13 & 0.07 & 0.05\end{matrix} ] ;$$

where, observation states to which each column in matrix B corresponds are (0, 0, 0), (0, 0, 1), (0, 1, 0), (0, 1, 1), (1, 0, 0), (1, 0, 1), (1, 1, 0), (1, 1, 1), respectively, and an observation initial probability π=(0.2, 0.4, 0.4).

In step 902, an optimal state sequence, i.e. an optimal path I*=(i₁*, i₂*, i₃*), is calculated by using the Viterbi algorithm according to the known observation sequence {(0, 1, 0), (1, 0, 0), (1, 1, 0)} and in conjunction with the above HMM; that is, an optimal path is selected from all possible paths, so as to determine classes of corresponding interference states. Following is detailed steps of processing:

(1) when t=1, for each interference state i, i=1(WiFi), 2(MWO), 3(Bluetooth), a probability at an interference state i and an observation state (0, 1, 0) is calculated, which is denoted by δ₁(i), then

δ₁(i)=πᵢbᵢ{(0,1,0)},i=1,2,3;

where, bᵢ{(0, 1, 0)} denotes an element in matrix B to which the observation state (0, 1, 0) corresponds;

after substitution with actual data, it is calculated that:

δ₁(1)=0.01, δ₁(2)=0.028, δ₁(3)=0.012;

(2) when t=2, for each interference state i, i=1, 2, 3, a maximum probability of a path when t=1 at an interference state j and an observation state (0, 1, 0) and when t=2 at an interference state i and an observation state (1, 0, 0) is calculated, which is denoted by δ₂ (i), then

$${δ}_{2} ( i ) = {max}_{1 \leq j \leq 3} [ {δ}_{1} ( j ) {a}_{ji} ] {b}_{i} \{ ( 1 , 0 , 0 ) \} ;$$

where, aⱼᵢ denotes an element in matrix A, bᵢ{(1, 0, 0)} denotes an element in matrix B to which the observation state (1, 0, 0) corresponds;

and at the same time, for each interference state i, i=1, 2, 3, a preceding interference state j=Ψ₂(i) of the path of the maximum probability is recorded (the current interference state is i):

$${Ψ}_{2} ( i ) = arg {max}_{1 \leq j \leq 3} [ {δ}_{1} ( j ) {a}_{ji} ] ,$$

i=1, 2, 3;

after substitution with actual data, it is calculated that:

$${δ}_{2} ( 1 ) = {max}_{1 \leq j \leq 3} ⌊ {δ}_{1} ( j ) {a}_{ji} ⌋ {b}_{1} \{ ( 1 , 0 , 0 ) \} = {max}_{1 \leq j \leq 3} \{ 0.01 \times 0.5 , 0.028 \times 0.3 , 0.012 \times 0.2 ) \} \times 0.06 = 0.000324$$

$${Ψ}_{2} ( 1 ) = 2 ; {δ}_{2} ( 2 ) = 0.0014 , {Ψ}_{2} ( 2 ) = 2 ; {δ}_{2} ( 3 ) = 0.00048 , {Ψ}_{2} ( 3 ) = 3 ;$$

likewise, when t=3,

$${δ}_{3} ( i ) = {max}_{1 \leq j \leq 3} [ {δ}_{2} ( j ) {a}_{ji} ] {b}_{i} \{ ( 1 , 1 , 0 ) \} ; {Ψ}_{3} ( i ) = arg {max}_{1 \leq j \leq 3} [ {δ}_{2} ( j ) {a}_{ji} ] ,$$

are calculated, i=1, 2, 3; after substitution with actual data, it is calculated that: δ₃ (1)=0.0000588, Ψ₃(1)=2; δ₃(2)=0.000021, Ψ₃(2)=2; δ₃(3)=0.0000196, Ψ₃(3)=2;

(3) a probability of the optimal path is denoted by P*, then

$${P}^{*} = {max}_{1 \leq j \leq 3} {δ}_{3} ( i ) = 0.000058 ,$$

and an endpoint of the optimal path is

$${i}_{3}^{*} = arg {max}_{i} [ {δ}_{3} ( i ) ] = 1 ;$$

(4) i₂*, i₁* are found in a reverse manner from the endpoint of the optimal path i₃*; when t=2, i₂*=Ψ₃(i₃*)=Ψ₃(1)=2; and when t=1, i₁*=Ψ₂(i₂*)=Ψ₂(2)=2.

Hence, Zigbee is subjected to interference from MWO, MWO and WiFi at an optimal state sequence I*=(i₁*, i₂*, i₃*)=(2, 2, 1), that is, when the observation sequence is O={(0, 1, 0), (1, 0, 0), (1, 1, 0)}.

With the above embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

### Embodiment 5

Embodiment 5 provides a parameter determination apparatus. As a principle of the apparatus for solving problems is similar to that of the method of Embodiment 1, the implementation of the method of Embodiment 1 may be referred to for implementation of the apparatus, with repeated parts being not going to be described herein any further.

In this embodiment, M groups of parameters are determined for a scenario where each of a first to an M-th interference sources is a primary interference source interfering with the current network, so that matrix B in the HMM is constructed by the M groups of parameters. Wherein, a scenario where an interference source is a primary interference source is taken as an interference state. Hence, there exist total M interference states.

FIG. 10 is a schematic diagram of the parameter determination apparatus of this embodiment. Wherein, when the number of interference sources interfering with a current network is M, the apparatus 1000 includes:

a first determining unit 1001 configured to determine M groups of parameters for M interference states of each of the M interference sources which is a primary interference source interfering with the current network, each group of parameters including N1 parameter values, a sum of the N1 parameter values being equal to 1;

In this embodiment, the first determining unit 1001 includes: a first detecting unit 10011, a first processing unit 10012 and a second determining unit 10013, in determining a group of parameters in an interference state,

the first detecting unit 10011 being configured to, for T moments, detect predetermined K first network parameters at each moment, so as to obtain a first parameter sequence constituted by the K first network parameters at the T moments;

the first processing unit 10012 being configured to optimize the K first network parameters at each moment, so as to obtain a second parameter sequence constituted by K second parameters at the T moments obtained by optimizing the first network parameters;

and the second determining unit 10013 being configured to determine probabilities of occurrence of N1 parameter states at the interference state according to the second parameter sequence, and take the probabilities as the N1 parameter values; wherein, the parameter states are determined by L second parameters to which L predetermined conditions correspond, N1=L^{K};

and in this embodiment, in optimizing the fourth number of first network parameters at each moment, the first processing unit 10012 is further configured to respectively determine one of L predetermined conditions satisfied by each of the K first network parameters, and convert each of the first network parameters into a second parameter to which a predetermined condition satisfied by the first network parameter correspond, so as to obtain K second parameters at the moment; wherein, each of the predetermined conditions respectively corresponds to a second parameter, and different predetermined conditions correspond to different second parameters.

In this embodiment, steps 201-203 in Embodiment 1 may be referred to for implementations of the first detecting unit 10011, the first processing unit 10012 and the second determining unit 10013, and shall not be described herein any further.

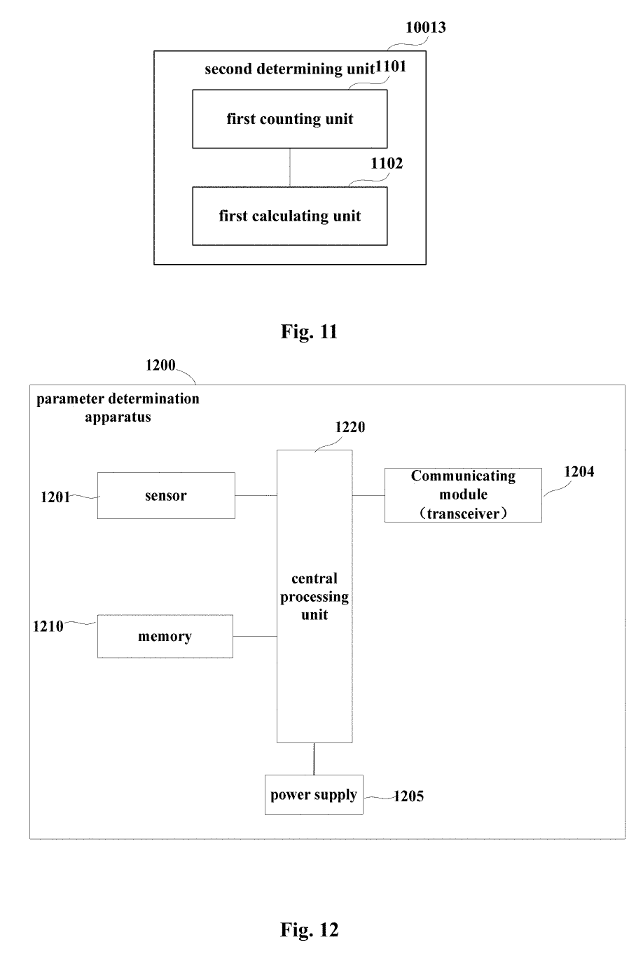

FIG. 11 is a schematic diagram of the second determining unit 10013 of this embodiment. As shown in FIG. 11, the second determining unit 10013 includes:

a first counting unit 1101 configured to count the number of times of occurrence of each of the N1 parameter states at the T moments in the second parameter sequence; and

a first calculating unit 1102 configured to divide the number of times of occurrence of each parameter state by T, so as to obtain the probabilities of occurrence of the N1 parameter states, and take the probabilities as the N1 parameter values.

In this embodiment, steps 401-402 in Embodiment 1 may be referred to for implementations of the first counting unit 1101 and the first calculating unit 1102, and shall not be described herein any further.

In this embodiment, the first processing unit 10012 further includes: a first setting unit (not shown) configured to set L second parameters to which the L predetermined conditions correspond for each of the K first network parameters.

In this embodiment, the first setting unit sets the L second parameters to which the L predetermined conditions correspond by using L−1 threshold values.

In this embodiment, for each first network parameter, when L is 2, the number of the threshold values is 1, the first processing unit 10012 converts the first network parameter into a first numeral value when the first network parameter is greater than the threshold value, and converts the first network parameter into a second numeral value when the first network parameter is less than or equal to the threshold value.

With the above embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

FIG. 12 is a schematic diagram of a hardware structure of the parameter determination apparatus of this embodiment. As shown in FIG. 12, the apparatus 1200 may include an interface (not shown), a central processing unit (CPU) 1220 and a memory 1210, the memory 1210 being coupled to the central processing unit 1220. Wherein, the memory 1210 may store various data, and furthermore, it may store a program for parameter determination, execute the program under control of the central processing unit 1220, and store various threshold values, etc.

In an implementation, the functions of the parameter determination apparatus may be integrated into the central processing unit 1220. Wherein, the central processing unit 1220 may be configured to: determine M groups of parameters for M interference states of each of the M interference sources which is a primary interference source interfering with the current network, each group of parameters including N1 parameter values, a sum of the second number of parameter values being equal to 1; in determining a group of parameters in an interference state, the central processing unit 1220 may be configured to: for T moments, detect a predetermined K first network parameters at each moment, so as to obtain a first parameter sequence constituted by the K first network parameters at the T moments, optimize the K first network parameters at each moment, so as to obtain a second parameter sequence constituted by K second parameters at the T moments obtained by optimizing the first network parameters; determine probabilities of occurrence of N1 parameter states at the interference state according to the second parameter sequence, and take the probabilities as the N1 parameter values; wherein, the parameter states are determined by L second parameters to which L predetermined conditions correspond, N1=L^{K};

In this embodiment, in optimizing the fourth number of first network parameters at each moment, the central processing unit 1220 may be configured to: respectively determine one of L predetermined conditions satisfied by each of the K first network parameters, and convert each of the first network parameters into a second parameter to which a predetermined condition satisfied by the first network parameter correspond, so as to obtain K second parameters at the moment; wherein, each of the predetermined conditions respectively corresponds to a second parameter, and different predetermined conditions correspond to different second parameters.

In this embodiment, the central processing unit 1220 may further be configured to: count the number of times of occurrence of each of the N1 parameter states at the T moments in the second parameter sequence; and divide the number of times of occurrence of each parameter state by T, so as to obtain the probabilities of occurrence of the N1 parameter states, and take the probabilities as the N1 parameter values.

Wherein, the central processing unit 1220 may further be configured to: set L second parameters to which the L predetermined conditions correspond for each of the K first network parameters; set the L second parameters to which the L predetermined conditions correspond by using L−1 threshold values; and for each first network parameter, when L is 2, the number of the threshold values is 1, convert the first network parameter into a first numeral value when the first network parameter is greater than the threshold value, and convert the first network parameter into a second numeral value when the first network parameter is less than or equal to the threshold value.

In another implementation, the above parameter determination apparatus may be configured on a chip (not shown) connected to the central processing unit 1220, with the functions of the parameter determination apparatus being carried out under control of the central processing unit 1220.

In this embodiment, the apparatus 1200 may further include a sensor 1201, a transceiver 1204, and a power supply module 1205, etc.; wherein, functions of these components are similar to the prior art, and shall not be described herein any further. It should be noted that the apparatus 1200 does not necessarily include all the parts shown in FIG. 12, and furthermore, the apparatus 1200 may include parts not shown in FIG. 12, and the prior art may be referred to.

With the above embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

### Embodiment 6

Embodiment 6 provides a parameter determination apparatus. As a principle of the apparatus for solving problems is similar to that of the method of Embodiment 2, the implementation of the method of Embodiment 2 may be referred to for implementation of the apparatus, with repeated parts being not going to be described herein any further.

In this embodiment, M groups of parameters are determined for a scenario where each of a first to an M-th interference sources is a primary interference source interfering with the current network, so that matrix A in the HMM is constructed by the M groups of parameters. Wherein, a scenario where an interference source is a primary interference source is taken as an interference state. Hence, there exist total M interference states.

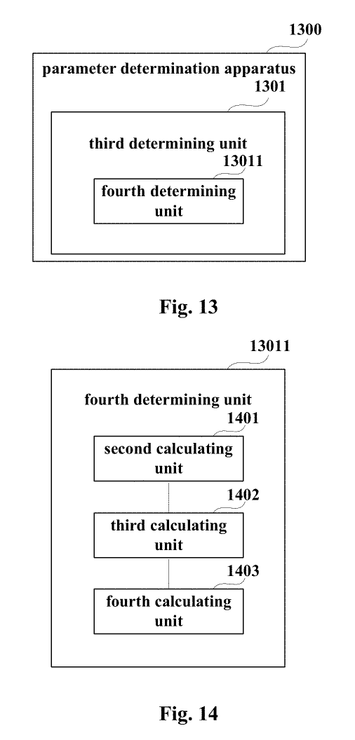

FIG. 13 is a schematic diagram of an implementation of the parameter determination apparatus of this embodiment. When the number of the interference sources interfering with the current network is M, the apparatus 1300 includes:

a third determining unit 1301 configured to determine M groups of parameters for M interference states of each of the M interference sources which is a primary interference source interfering with the current network, each group of parameters including a first number M of parameter values, a sum of the M parameter values being equal to 1;

In this embodiment, the third determining unit 1301 includes a fourth determining unit 13011, in determining a group of parameters in an interference state, the fourth determining unit 13011 being configured to determine at the interference state, the first number of conversion probabilities of a first interference source at a first moment in being respectively converted into different second interference sources at a second moment, by using channels occupied by the interference source and signal strength of the interference source, so as to obtain the first number of parameter values;

In this embodiment, the first interference source at the first moment is a primary interference source at the interference state, and the second interference sources at the second moment are the primary interference source and other M−1 interference sources than the primary interference source, respectively.

In this embodiment, Embodiment 2 may be referred to for particular implementation of the third determining unit 1301, which shall not be described herein any further.

FIG. 14 is a schematic diagram of the fourth determining unit 13011 of this embodiment. As shown in FIG. 14, the fourth determining unit 13011 includes:

a second calculating unit 1401 configured to determine a first probability of existence of the second interference state at the second moment according to channels occupied by the second interference source at the second moment;

a third calculating unit 1402 configured to determine a second probability that signal strength of the second interference source is greater than signal strength of other interference sources than the second interference source; and

a fourth calculating unit 1403 configured to take a product of the first probability and the second probability as the conversion probability.

When the second interference source is Bluetooth and the current network is Zigbee, the second calculating unit 1401 takes a hopping probability that a channel used by Bluetooth coincides with a channel used by Zigbee as the first probability;

when the second interference source is Wi-Fi and the current network is Zigbee, the second calculating unit 1401 takes a probability that a channel frequency used by Wi-Fi coincides with a channel used by Zigbee as the first probability;

and when the second interference source is an MWO and the current network is Zigbee, the second calculating unit 1401 takes a probability that a frequency used by the microwave oven coincides with a channel used by Zigbee as the first probability.

In this embodiment, steps 601-603 in Embodiment 2 may be referred to for implementations of the second calculating unit 1401, the third calculating unit 1402 and the fourth calculating unit 1403, and shall not be described herein any further.

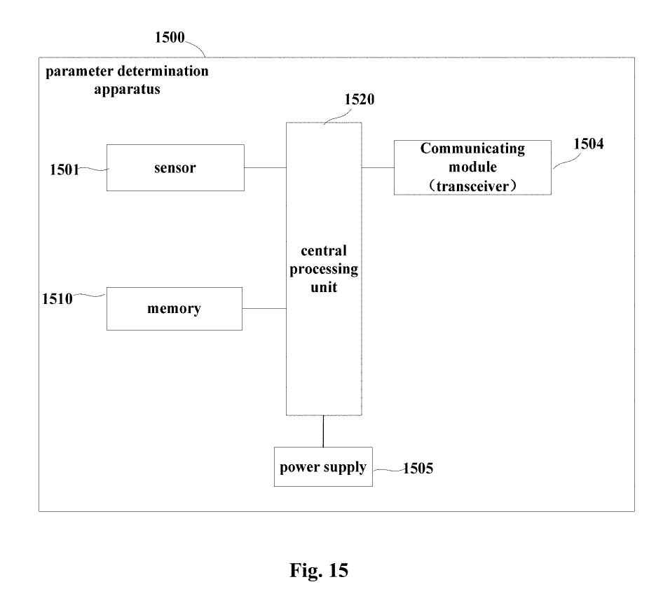

FIG. 15 is a schematic diagram of a hardware structure of the parameter determination apparatus of this embodiment. As shown in FIG. 15, the apparatus 1500 may include an interface (not shown), a central processing unit (CPU) 1520 and a memory 1510, the memory 1510 being coupled to the central processing unit 1520. Wherein, the memory 1510 may store various data, and furthermore, it may store a program for parameter determination, execute the program under control of the central processing unit 1520, and store various threshold values, etc.

In an implementation, the functions of the parameter determination apparatus may be integrated into the central processing unit 1520. Wherein, the central processing unit 1520 may be configured to: determine M groups of parameters for M interference states of each of the M interference sources which is a primary interference source interfering with the current network, each group of parameters including M parameter values, a sum of the M parameter values being equal to 1;

In this embodiment, in determining a group of parameters in an interference state, the central processing unit 1520 may be configured to: determine at the interference state, the M conversion probabilities of a first interference source at a first moment in being respectively converted into different second interference sources at a second moment, by using channels occupied by the interference source and signal strength of the interference source, so as to obtain the M parameter values; wherein, the first interference source at the first moment is a primary interference source at the interference state, and the second interference sources at the second moment are the primary interference source and other M−1 interference sources than the primary interference source, respectively.

In this embodiment, in calculating one of the conversion probabilities, the central processing unit 1520 may further be configured to: determine a first probability of existence of the second interference source at the second moment according to channels occupied by the second interference source at the second moment; determine a second probability that signal strength of the second interference source is greater than signal strength of other interference sources than the second interference source; and take a product of the first probability and the second probability as the conversion probability.

In this embodiment, the central processing unit 1520 may further be configured to: when the second interference source is Bluetooth and the current network is Zigbee, take a hopping probability that a channel used by Bluetooth coincides with a channel used by Zigbee as the first probability; when the second interference source is Wi-Fi and the current network is Zigbee, take a probability that a channel frequency used by Wi-Fi coincides with a channel used by Zigbee as the first probability; and when the second interference source is a microwave oven and the current network is Zigbee, take a probability that a frequency used by the microwave oven coincides with a channel used by Zigbee as the first probability.

In another implementation, the above parameter determination apparatus may be configured on a chip (not shown) connected to the central processing unit 1520, with the functions of the parameter determination apparatus being carried out under control of the central processing unit 1520.

In this embodiment, the apparatus 1500 may further include a sensor 1501, a transceiver 1504, and a power supply module 1505, etc.; wherein, functions of these components are similar to the prior art, and shall not be described herein any further. It should be noted that the apparatus 1500 does not necessarily include all the parts shown in FIG. 15, and furthermore, the apparatus 1500 may include parts not shown in FIG. 15, and the prior art may be referred to.

With the above embodiment, parameters in the HMM are relatively easy to be determined. Furthermore, based on the determined parameters in the HMM and in conjunction with an observed parameter sequence, the problem of interference classification and identification may be converted into a problem of decoding, which lowers the complexity in achievement.

### Embodiment 7

Embodiment 7 provides a modeling apparatus. As a principle of the apparatus for solving problems is similar to that of the method of Embodiment 3, the implementation of the method of Embodiment 3 may be referred to for implementation of the apparatus, with repeated parts being not going to be described herein any further.

An HHM λ=(A, B, π) is used to construct an interference classification and identification model; where, A is a hidden state transition probability matrix, B is an observation state transition probability matrix, and π is an initial probability matrix. In this embodiment, each element in matrix A refers to a probability of conversion between interference states at neighboring moments, and each element in matrix B refers to a probability of occurrence of a network parameter in an interference state which represents a network state.

In this embodiment, when the number of the interference sources interfering with the current network is a first number (M), the apparatus includes:

the parameter determination apparatus in Embodiment 5, and/or the parameter determination apparatus in Embodiment 6; wherein, M×N1 parameters determined by using the parameter determination apparatus in Embodiment 5 are taken as matrix B in the model, and M×M parameters determined by using the parameter determination apparatus in Embodiment 6 are taken as matrix A in the model.

In this embodiment, the modeling apparatus takes initial probabilities of occurrence of the interference states as an initial probability matrix π.

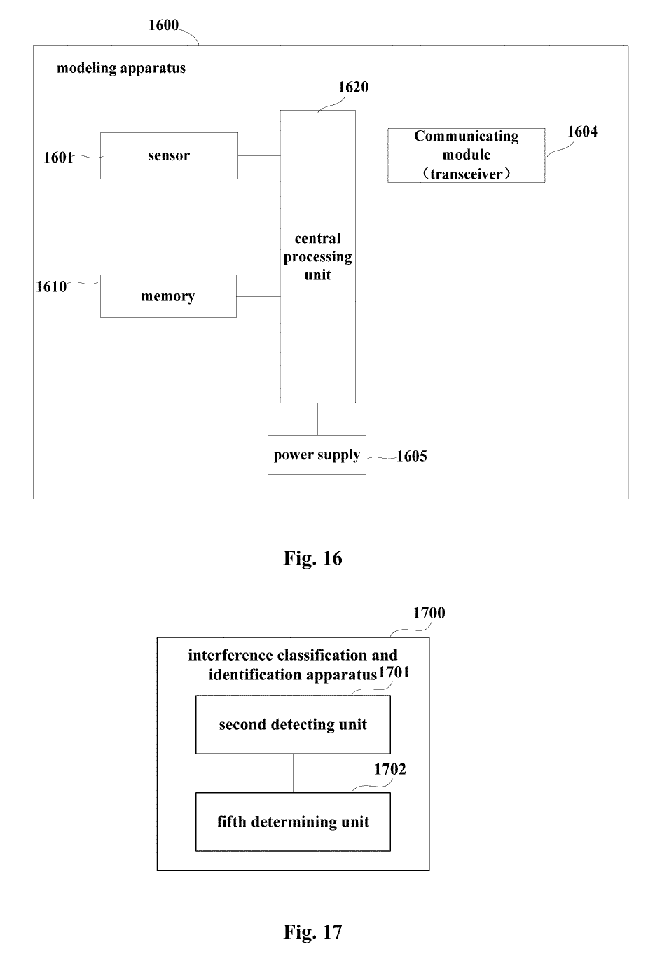

FIG. 16 is a schematic diagram of a hardware structure of the modeling apparatus of the embodiment of this disclosure. As shown in FIG. 16, the apparatus 1600 may include an interface (not shown), a central processing unit (CPU) 1620 and a memory 1610, the memory 1610 being coupled to the central processing unit 1620. Wherein, the memory 1610 may store various data, and furthermore, it may store a program for modeling, and execute the program under control of the central processing unit 1620.

In an implementation, the functions of the modeling apparatus may be integrated into the central processing unit 1620. Wherein, the central processing unit 1620 may be configured to: carry out the functions of the central processing unit 1020 in Embodiment 5 and/or the functions of the central processing unit 1320 in Embodiment 6.

In another implementation, the modeling apparatus may be configured on a chip (not shown) connected to the central processing unit 1620, with the functions of the modeling apparatus being carried out under control of the central processing unit 1620.

In this embodiment, the apparatus 1600 may further include a sensor 1601, a transceiver 1604, and a power supply module 1605, etc.; wherein, functions of these components are similar to the prior art, and shall not be described herein any further. It should be noted that the apparatus 1600 does not necessarily include all the parts shown in FIG. 16, and furthermore, the apparatus 1600 may include parts not shown in FIG. 16, and the prior art may be referred to.

With the above embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

### Embodiment 8

Embodiment 8 provides an interference classification and identification apparatus. As a principle of the apparatus for solving problems is similar to that of the method of Embodiment 4, the implementation of the method of Embodiment 4 may be referred to for implementation of the apparatus, with repeated parts being not going to be described herein any further.

In this embodiment, the number of interference sources interfering with a current network is a first number (M), a scenario where one of the M interference sources is a primary interference source interfering with the current network being taken as an interference state. Hence, there exist total M interference states.

FIG. 17 is a schematic diagram of the interference classification and identification apparatus of this embodiment. When the number of interference sources interfering with a current network is M, the apparatus 1700 includes:

a second detecting unit 1701 configured to, for a sixth number Q of moments, detect K first network parameters at each moment, so as to obtain a third parameter sequence constituted by the K first network parameters at the Q moments; and a fifth determining unit 1702 configured to respectively determine classes of interference states existing at the Q moments according to the third parameter sequence and a hidden Markov model;

In this embodiment, the apparatus further includes:

the parameter determination apparatus (not shown) in Embodiment 5 configured to determine a first parameter for interference classification and identification, the first parameter being an observation state transition probability matrix in the hidden Markov model; and/or

the parameter determination apparatus (not shown) in Embodiment 6 configured to determine a second parameter for interference classification and identification, the second parameter being a hidden state transition probability matrix in the hidden Markov model.

In this embodiment, steps 901-902 in Embodiment 4 may be referred to for implementations of the second detecting unit 1701 and the fifth determining unit 1702, and shall not be described herein any further.

In this embodiment, the first parameter is a matrix constituted by parameters of a number of the first number multiplied by the second number, and the second parameter is a matrix constituted by parameters of a number of the first number multiplied by the first number.

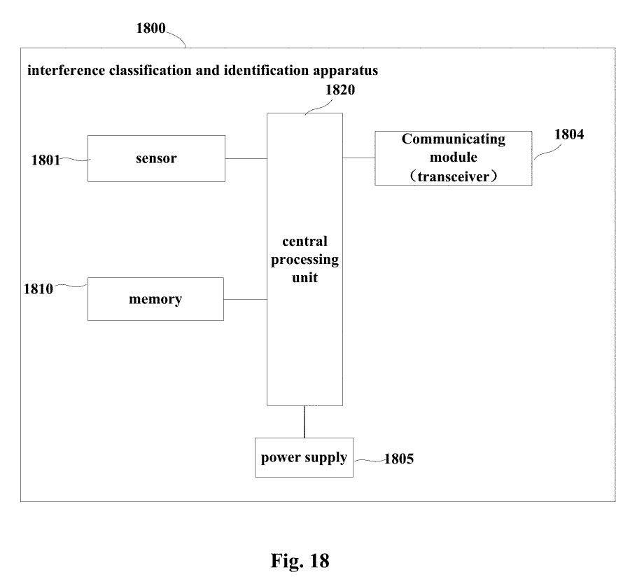

FIG. 18 is a schematic diagram of a hardware structure of the interference classification and identification apparatus of this embodiment. As shown in FIG. 18, the apparatus 1800 may include an interface (not shown), a central processing unit (CPU) 1820 and a memory 1810, the memory 1810 being coupled to the central processing unit 1820. Wherein, the memory 1810 may store various data, and furthermore, it may store a program for interference classification and identification, execute the program under control of the central processing unit 1820, and store various threshold values, etc.

In an implementation, the functions of the interference classification and identification apparatus may be integrated into the central processing unit 1820. Wherein, the central processing unit 1820 may be configured to: for Q moments, detect K first network parameters at each moment, so as to obtain a third parameter sequence constituted by the K first network parameters at the Q moments; and respectively determine classes of interference states existing at the Q moments according to the third parameter sequence and a hidden Markov model

Wherein, the central processing unit 1820 may be configured to: carry out the functions of the central processing unit 1420 in Embodiment 7.

In another implementation, the above classification and identification apparatus may be configured on a chip (not shown) connected to the central processing unit 1820, with the functions of the classification and identification apparatus being carried out under control of the central processing unit 1820.

In this embodiment, the apparatus 1800 may further include a sensor 1801, a transceiver 1804, and a power supply module 1805, etc.; wherein, functions of these components are similar to the prior art, and shall not be described herein any further. It should be noted that the apparatus 1800 does not necessarily include all the parts shown in FIG. 18, and furthermore, the apparatus 1800 may include parts not shown in FIG. 18, and the prior art may be referred to.

With the above embodiment, parameters in the HMM are relatively easy to be determined; wherein, by simplifying a parameter sequence based on a threshold value, complexity in constructing the above matrix B is lowered. Furthermore, based on the determined parameters in the HMM and in conjunction with an observed parameter sequence, the problem of interference classification and identification may be converted into a problem of decoding, which lowers the complexity in achievement.

An embodiment of the present disclosure provides a computer readable program code, which, when executed in a parameter determination apparatus, will cause a computer unit to carry out the parameter determination method as described in Embodiment 1 or 2 in the parameter determination apparatus.

An embodiment of the present disclosure provides a computer readable medium, including a computer readable program code, which will cause a computer unit to carry out the parameter determination method as described in Embodiment 1 or 2 in a parameter determination apparatus.

An embodiment of the present disclosure provides a computer readable program code, which, when executed in a modeling apparatus, will cause a computer unit to carry out the modeling method as described in Embodiment 3 in the modeling apparatus.

An embodiment of the present disclosure provides a computer readable medium, including a computer readable program code, which will cause a computer unit to carry out the modeling method as described in Embodiment 3 in a modeling apparatus.

An embodiment of the present disclosure provides a computer readable program code, which, when executed in an interference classification and identification apparatus, will cause a computer unit to carry out the interference classification and identification method as described in Embodiment 4 in the interference classification and identification apparatus.

An embodiment of the present disclosure provides a computer readable medium, including a computer readable program code, which will cause a computer unit to carry out the interference classification and identification method as described in Embodiment 4 in an interference classification and identification apparatus.

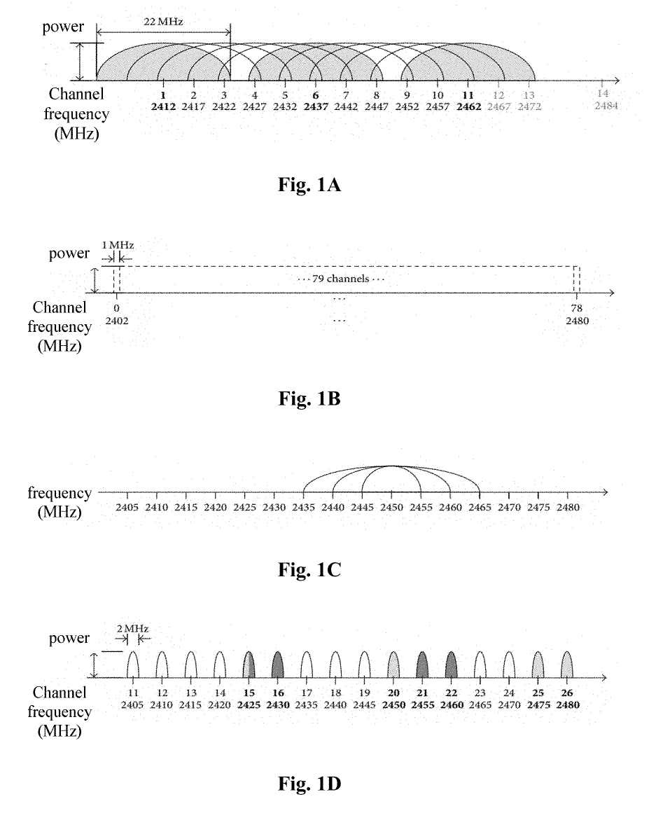

The method for forming images in the image forming apparatus described in conjunction with the embodiments of this disclosure may be directly embodied as hardware, software modules executed by a processor, or a combination thereof. For example, one or more functional block diagrams and/or one or more combinations of the functional block diagrams shown in FIGS. 8-18 may either correspond to software modules of procedures of a computer program, or correspond to hardware modules. Such software modules may respectively correspond to the steps shown in FIGS. 1-7. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 8-18 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams shown in FIGS. 8-18 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

For implementations of the present invention containing the above embodiments, following supplements are further disclosed.

Supplement 1. A parameter determination apparatus for interference classification and identification, wherein the number of interference sources interfering with a current network is M, the apparatus including:

a first determining unit configured to determine M groups of parameters for M interference states of each of the M interference sources which is a primary interference source interfering with the current network, each group of parameters including a second number N1 of parameter values, a sum of the N1 parameter values being equal to 1;

wherein, the first determining unit includes: a first detecting unit, a first processing unit and a second determining unit, in determining a group of parameters in an interference state, the first detecting unit being configured to, for a third number T of moments, detect a predetermined fourth number K of first network parameters at each moment, so as to obtain a first parameter sequence constituted by the K first network parameters at the T moments;

the first processing unit being configured to optimize the K first network parameters at each moment, so as to obtain a second parameter sequence constituted by K second parameters at the T moments obtained by optimizing the first network parameters;

and the second determining unit being configured to determine probabilities of occurrence of N1 parameter states at the interference state according to the second parameter sequence, and take the probabilities as the N1 parameter values; wherein, the parameter states are determined by L second parameters to which a fifth number L of predetermined conditions correspond, N1=L^{K};

and wherein, in optimizing the K first network parameters at each moment, the first processing unit is further configured to respectively determine one of L predetermined conditions satisfied by each of the K first network parameters, and convert each of the first network parameters into a second parameter to which a predetermined condition satisfied by the first network parameter correspond, so as to obtain K second parameters at the moment; wherein, each of the predetermined conditions respectively corresponds to a second parameter, and different predetermined conditions correspond to different second parameters.

Supplement 2. The apparatus according to supplement 1, wherein the second determining unit includes:

a first counting unit configured to count the number of times of occurrence of each of the N1 parameter states at the T moments in the second parameter sequence; and

a first calculating unit configured to divide the number of times of occurrence of each parameter state by T, so as to obtain the probabilities of occurrence of the N1 parameter states, and take the probabilities as the N1 parameter values.

Supplement 3. The apparatus according to supplement 1, wherein the first processing unit further includes:

a first setting unit configured to set L second parameters to which the L predetermined conditions correspond for each of the K first network parameters.

Supplement 4. The apparatus according to supplement 3, wherein the first setting unit sets the L second parameters to which the L predetermined conditions correspond by using L−1 threshold values.

Supplement 5. The apparatus according to supplement 4, wherein for each first network parameter, when L is 2, the number of the threshold values is 1, the first processing unit converts the first network parameter into a first numeral value when the first network parameter is greater than the threshold value, and converts the first network parameter into a second numeral value when the first network parameter is less than or equal to the threshold value.

Supplement 6. The apparatus according to supplement 5, wherein the first numeral value and the second numeral value are numeral values that can be used for counting.

Supplement 7. The apparatus according to supplement 6, wherein the first numeral value is 1, and the second numeral value is 0; or the first numeral value is 0, and the second numeral value is 1.

Supplement 8. The apparatus according to supplement 4, wherein threshold values set for each of the K first network parameters are different.

Supplement 9. The apparatus according to supplement 1, wherein the current network is Zigbee;

and the interference sources include one or more of the following: WiFi, MWO, and Bluetooth.

Supplement 10. The apparatus according to supplement 1, wherein the first network parameters include one or more of the following parameters: RSSI, LQI, and CCA.

Supplement 11. A parameter determination apparatus for interference classification and identification, wherein the number of interference sources interfering with a current network is M, the apparatus including:

a third determining unit configured to determine a first number of groups of parameters for a first number of interference states of each of the first number of interference sources which is a primary interference source interfering with the current network, each group of parameters including the first number of parameter values, a sum of the first number of parameter values being equal to 1;

wherein, the third determining unit includes a fourth determining unit configured to, in determining a group of parameters in an interference state, determine at the interference state, the first number of conversion probabilities of a first interference source at a first moment in being respectively converted into different second interference sources at a second moment, by using channels occupied by the interference source and signal strength of the interference source, so as to obtain the first number of parameter values; wherein, the first interference source at the first moment is a primary interference source at the interference state, and the second interference sources at the second moment are the primary interference source and other interference sources than the primary interference source of a number of the first number minus 1, respectively.

Supplement 12. The apparatus according to supplement 11, wherein the fourth determining unit includes a second calculating unit, a third calculating unit and a fourth calculating unit, in calculating one of the conversion probabilities, the second calculating unit being configured to determine a first probability of existence of a second interference source at the second moment according to channels occupied by the second interference source at the second moment;

the third calculating unit being configured to determine a second probability that signal strength of the second interference source is greater than signal strength of other interference sources than the second interference source;

and the fourth calculating unit being configured to take a product of the first probability and the second probability as the conversion probability.

Supplement 13. The apparatus according to supplement 12, wherein when the second interference source is Bluetooth and the current network is Zigbee, the second calculating unit takes a hopping probability that a channel used by Bluetooth coincides with a channel used by Zigbee as the first probability;

when the second interference source is Wi-Fi and the current network is Zigbee, the second calculating unit takes a probability that a channel frequency used by Wi-Fi coincides with a channel used by Zigbee as the first probability;

and when the second interference source is a microwave oven and the current network is Zigbee, the second calculating unit takes a probability that a frequency used by the microwave oven coincides with a channel used by Zigbee as the first probability.

Supplement 14. The apparatus according to supplement 11, wherein the current network is Zigbee; and the interference sources are one or more of the following: WiFi, MWO, and Bluetooth.

Supplement 15. The apparatus according to supplement 11, wherein the signal strength is determined according to a parameter not changing along with the time.

Supplement 16. The apparatus according to supplement 15, wherein the parameter not changing along with the time is transmission power.

Supplement 17. An interference classification and identification apparatus, wherein the number of interference sources interfering with a current network is M, a scenario where one of the M interference sources is a primary interference source interfering with the current network being taken as an interference state, the apparatus including:

a second detecting unit configured to, for a sixth number Q of moments, detect K first network parameters at each moment, so as to obtain a third parameter sequence constituted by the K first network parameters at the Q moments;

a fifth determining unit configured to respectively determine classes of interference states existing at the Q moments according to the third parameter sequence and a hidden Markov model;

wherein, the apparatus further includes: the apparatus described in supplement 1 and configured to determine a first parameter for interference classification and identification, the first parameter being an observation state transition probability matrix in the hidden Markov model; and/or

the apparatus described in supplement 11 and configured to determine a second parameter for interference classification and identification, the second parameter being a hidden state transition probability matrix in the hidden Markov model.

Supplement 18. The apparatus according to supplement 17, wherein the first parameter is a matrix constituted by M×N1 parameters, and the second parameter is a matrix constituted by M×M parameters.

1. A parameter determination apparatus for interference classification and identification, wherein the number of interference sources interfering with a current network is M, the apparatus including:
a first determining unit configured to determine M groups of parameters for M interference states of each of the M interference sources which is a primary interference source interfering with the current network, each group of parameters including a second number N1 of parameter values, a sum of the N1 parameter values being equal to 1;
wherein, the first determining unit includes: a first detecting unit, a first processing unit and a second determining unit, in determining a group of parameters in an interference state, the first detecting unit being configured to, for a third number T of moments, detect a predetermined fourth number K of first network parameters at each moment, so as to obtain a first parameter sequence constituted by the K first network parameters at the T moments;
the first processing unit being configured to optimize the K first network parameters at each moment, so as to obtain a second parameter sequence constituted by K second parameters at the T moments obtained by optimizing the first network parameters;
and the second determining unit being configured to determine probabilities of occurrence of N1 parameter states at the interference state according to the second parameter sequence, and take the probabilities as the N1 parameter values; wherein, the parameter states are determined by L second parameters to which a fifth number L of predetermined conditions correspond, N1=L^{K};
and wherein, in optimizing the K first network parameters at each moment, the first processing unit is further configured to respectively determine one of L predetermined conditions satisfied by each of the K first network parameters, and convert each of the first network parameters into a second parameter to which a predetermined condition satisfied by the first network parameter correspond, so as to obtain K second parameters at the moment; wherein, each of the predetermined conditions respectively corresponds to a second parameter, and different predetermined conditions correspond to different second parameters.

2. The apparatus according to claim 1, wherein the second determining unit includes:
a first counting unit configured to count the number of times of occurrence of each of the N1 parameter states at the T moments in the second parameter sequence; and
a first calculating unit configured to divide the number of times of occurrence of each parameter state by T, so as to obtain the probabilities of occurrence of the N1 parameter states, and take the probabilities as the N1 parameter values.

3. The apparatus according to claim 1, wherein the first processing unit further includes:
a first setting unit configured to set L second parameters to which the L predetermined conditions correspond for each of the K first network parameters.

4. The apparatus according to claim 3, wherein the first setting unit sets the L second parameters to which the L predetermined conditions correspond by using L−1 threshold values.

5. The apparatus according to claim 4, wherein for each first network parameter, when L is 2, the number of the threshold values is 1, the first processing unit converts the first network parameter into a first numeral value when the first network parameter is greater than the threshold value, and converts the first network parameter into a second numeral value when the first network parameter is less than or equal to the threshold value.

6. The apparatus according to claim 5, wherein the first numeral value and the second numeral value are numeral values that can be used for counting.

7. The apparatus according to claim 6, wherein the first numeral value is 1, and the second numeral value is 0; or the first numeral value is 0, and the second numeral value is 1.

8. The apparatus according to claim 4, wherein threshold values set for each of the K first network parameters are different.

9. The apparatus according to claim 1, wherein the current network is Zigbee;
and the interference sources include one or more of the following: WiFi, MWO, and Bluetooth.

10. The apparatus according to claim 1, wherein the first network parameters include one or more of the following parameters: RSSI, LQI, and CCA.

11. A parameter determination apparatus for interference classification and identification, wherein the number of interference sources interfering with a current network is M, the apparatus including:
a third determining unit configured to determine a first number of groups of parameters for a first number of interference states of each of the first number of interference sources which is a primary interference source interfering with the current network, each group of parameters including the first number of parameter values, a sum of the first number of parameter values being equal to 1;
wherein, the third determining unit includes a fourth determining unit configured to, in determining a group of parameters in an interference state, determine at the interference state, the first number of conversion probabilities of a first interference source at a first moment in being respectively converted into different second interference sources at a second moment, by using channels occupied by the interference source and signal strength of the interference source, so as to obtain the first number of parameter values; wherein, the first interference source at the first moment is a primary interference source at the interference state, and the second interference sources at the second moment are the primary interference source and other interference sources than the primary interference source of a number of the first number minus 1, respectively.

12. The apparatus according to claim 11, wherein the fourth determining unit includes a second calculating unit, a third calculating unit and a fourth calculating unit, in calculating one of the conversion probabilities, the second calculating unit being configured to determine a first probability of existence of a second interference source at the second moment according to channels occupied by the second interference source at the second moment;
the third calculating unit being configured to determine a second probability that signal strength of the second interference source is greater than signal strength of other interference sources than the second interference source;
and the fourth calculating unit being configured to take a product of the first probability and the second probability as the conversion probability.

13. The apparatus according to claim 12, wherein when the second interference source is Bluetooth and the current network is Zigbee, the second calculating unit takes a hopping probability that a channel used by Bluetooth coincides with a channel used by Zigbee as the first probability;
when the second interference source is Wi-Fi and the current network is Zigbee, the second calculating unit takes a probability that a channel frequency used by Wi-Fi coincides with a channel used by Zigbee as the first probability;
and when the second interference source is a microwave oven and the current network is Zigbee, the second calculating unit takes a probability that a frequency used by the microwave oven coincides with a channel used by Zigbee as the first probability.

14. The apparatus according to claim 11, wherein the current network is Zigbee; and the interference sources are one or more of the following: WiFi, MWO, and Bluetooth.

15. The apparatus according to claim 11, wherein the signal strength is determined according to a parameter not changing along with the time.

16. The apparatus according to claim 15, wherein the parameter not changing along with the time is transmission power.

17. An interference classification and identification apparatus, wherein the number of interference sources interfering with a current network is M, a scenario where one of the M interference sources is a primary interference source interfering with the current network being taken as an interference state, the apparatus including:
a second detecting unit configured to, for a sixth number Q of moments, detect K first network parameters at each moment, so as to obtain a third parameter sequence constituted by the K first network parameters at the Q moments;
a fifth determining unit configured to respectively determine classes of interference states existing at the Q moments according to the third parameter sequence and a hidden Markov model;
wherein, the apparatus further includes: the apparatus described in supplement 1 and configured to determine a first parameter for interference classification and identification, the first parameter being an observation state transition probability matrix in the hidden Markov model; and/or
the apparatus described in supplement 11 and configured to determine a second parameter for interference classification and identification, the second parameter being a hidden state transition probability matrix in the hidden Markov model.

18. The apparatus according to claim 17, wherein the first parameter is a matrix constituted by M×N1 parameters, and the second parameter is a matrix constituted by M×M parameters.
